(19) United States
(12) Patent Application Publication
(10) Pub. No.: US 2023/0302465 A1
(43) Pub. Date: Sep. 28, 2023

(54) APPARATUS FOR SEPARATING COMPONENTS OF A SUSPENSION

(71) Applicant: GM INNOVATIONS LIMITED, Glasgow (GB)

(72) Inventor: Gerard MELLING, Glasgow (GB)

(73) Assignee: GM INNOVATIONS LIMITED, Glasgow (GB)

(21) Appl. No.: 18/006,270

(22) PCT Filed: Jul. 20, 2021
(86) PCT No.: PCT/EP2021/070296

§ 371 Date: Jan. 20, 2023

(30) Foreign Application Priority Data
Jul. 21, 2020 (GB) 2011286.8
Mar. 12, 2021 (GB) 2103464.0

(51) Int. Cl. B03B 5/34; B04B 11/02; B01D 21/26; B04B 1/02; B04B 5/10

(52) U.S. Cl. CPC B04B 5/10; B01D 21/262; B01D 21/265; B03B 5/34; B04B 1/02; B04B 11/02

(57) ABSTRACT

The invention provides an apparatus for separating components of a fluid stream, the apparatus comprising:
(a) a support structure on which is mounted a rotatable centrifugal separator chamber in which separation of the components of the fluid stream occurs;
(b) a fluid inlet for introducing a pressurised source of the fluid stream to be separated into the centrifugal separator chamber;
(c) a fluid outlet for collecting one or more separated components of the fluid stream;
(d) a vortex-creating device which rotates in order to introduce a vortex to the fluid stream in the centrifugal separation chamber thereby to bring about centrifugal separation of the components of the fluid stream;
and wherein the centrifugal separator chamber and vortex-creating device are configured to rotate independently of each other.
The invention also provides a method for separating components of a suspension, the method comprising passing the suspension through an apparatus as described herein.

This invention relates to an apparatus for separating components of a suspension, for example a suspension containing solids having different densities.

### BACKGROUND OF THE INVENTION

There is a need for an apparatus for separating components within a suspension that is robust, of simple construction, has a high throughput, and is readily portable. Such an apparatus is particularly desirable for mining applications, for example for separating particulates such as sand, grit, and mineral particulates from clays such as kaolin into fractions so that desired products such as metals (e.g. gold and rare earth elements) can be isolated.

WO 2018/154115 (GM Innovations Limited) discloses an apparatus for removing impurities from a fluid stream. The apparatus makes use of centrifugal separation for separating suspended materials from a fluid. The document also describes a vortex-separator device which can cause separation of components within a fluid stream by generating a vortex in a fixed tubular separator unit. This apparatus can be used in a continuous process for separating components within a fluid stream into two separate fluid streams.

While WO 2018/154115 describes the use of the apparatus to separate solids from liquids (e.g. sand from water), it does not describe the separation of two solids from each other. In addition, although the apparatus in WO 2018/154115 is suitable for separating two components of a fluid stream from each other, this apparatus is not described as being suitable for separating a fluid stream into three or more components.

There therefore exists the need for alternative separation apparatuses, particularly those that can be used to separate mixtures of solids having different densities.

### SUMMARY OF THE INVENTION

The present invention relates to an improved apparatus for separating components of a fluid stream. The improved apparatus has a greater separation efficiency and can be used to separate solids having different densities.

Accordingly, in a first aspect of the invention, there is provided an apparatus for separating components of a fluid stream, the apparatus comprising:
(a) a support structure on which is mounted a rotatable centrifugal separator chamber in which separation of the components of the fluid stream occurs;
(b) a fluid inlet for introducing a pressurised source of the fluid stream to be separated into the centrifugal separator chamber;
(c) a fluid outlet for collecting one or more separated components of the fluid stream;
(d) a vortex-creating device which rotates in order to introduce a vortex to the fluid stream in the centrifugal separation chamber thereby to bring about centrifugal separation of the components of the fluid stream;
and wherein the centrifugal separator chamber and vortex-creating device are configured to rotate independently of each other.

The apparatus comprises a rotating vortex-creating device which imparts a vortex to the fluid stream and a centrifugal separator chamber in which separation of the vortexed fluid stream occurs. By creating a vortex, the denser and less dense components within a fluid stream are separated by centrifugal forces as they travel along the separator chamber, the denser component(s) of the fluid being forced to the outer regions of the separator chamber, while the less dense components accumulate at or close to the longitudinal axis of the separator chamber. In this respect, the apparatus of the present invention operates in a similar manner to the apparatus described in our earlier application WO 2018/154115.

However, in contrast to the apparatus described in WO 2018/154115, where the separator chamber does not rotate, the apparatus of the present invention is constructed so that the separator chamber and the vortex-creating device each rotate independently (either in the same or opposite directions). As a result of this difference, the mechanism for the collection of the separated components of the fluid stream by the apparatus of the present invention may be different from the collection mechanism used by the apparatus of WO 2018/154115.

Thus, in the apparatus disclosed in WO2018/154115, the denser and less dense components within a fluid stream are separated by centrifugal forces as they travel along the separator unit, the denser component(s) of the fluid being forced to the outer regions of the separator chamber, whilst the less dense components accumulate at or close to the longitudinal axis of the separator chamber, and the denser component(s) are then collected through a radially outer annular collector channel whereas the less dense component(s) are collected by a radially inner central collector tube.

It will be appreciated that, if only one collector (e.g. the radially inner central collection tube) was present in the apparatus disclosed in WO2018/154115, then the separated more dense and less dense fractions would to a large extent converge at the central collector tube and recombine when leaving the separator unit; i.e. the net effect would be that no separation takes place.

However, according to the present invention, it has been found that by having a separator chamber and a vortex-creating device which each rotate independently, it is possible by controlling the relative speeds of rotation of the separator chamber and vortex-creating device to control the relative speeds at which the heavier (denser) components at the radially outer regions of the separator chamber and the lighter (less dense) components at the radially inner regions of the separator chamber move along the separator chamber. Thus, the heavier (denser) components at the radially outer regions of the separator chamber can be caused to move very slowly along the chamber, or their movement can even be arrested, while the lighter (less dense) components which collect at the radially inner regions of the chamber travel faster along the chamber. Therefore, by adjusting the relative speeds of rotation of the vortex-creating device and the separation chamber, different components of the fluid stream can be drawn out of the separator chamber through a central outlet at different times. Further control over the separation process can be exerted by varying the flow rate of the fluid through the separator.

Whereas the fluid dynamics within the separator chamber are complex, without wishing to be bound by any theory, a simplistic explanation for the phenomenon discussed above is that by rotating the separator chamber at a different speed to the vortex-creating device, a plurality of concentric layers or fluid streams are generated within the separator chamber, with fluid in each layer or stream travelling at a different longitudinal speed along the separator chamber. The central stream (which aligns with the vortex-creating device) travels at an increased speed relative to the outer regions as a result of the propulsion caused by the vortex-creating device.

By controlling the relative speeds of rotation of the vortex-creating device and the separation chamber, and the flow rate of the fluid through the chamber, the apparatus can be fine-tuned to separate a range of different components within the fluid stream.

For example, in a two-phase mixture containing heavy (dense) solid particles and lighter (less dense) solid particles, the relative speeds of rotation of the vortex-creating device and the separation chamber are set so that the dense particles collect in the radially outer region of the chamber and are held there while the less dense particles pass along the central region of the chamber and out through a central collector outlet. Once the less dense particles have been collected, the relative speeds of rotation of the vortex-creating device and the separation chamber and/or the flow rate of the fluid through the separator chamber are adjusted so that the denser particles move along the chamber to the central collector outlet.

The outlet (or outlets, when more than one outlet are present) is typically at a downstream end of the centrifugal separator chamber whereas the inlet (or inlets) is typically at an upstream end of the centrifugal separator chamber. In other words, the inlet(s) and outlet(s) are typically positioned at opposing ends of the centrifugal separator chamber. This enables a more laminar flow of fluid passing through the centrifugal separator chamber and thereby improves separation efficiency.

Although excellent separation can be achieved by using only one outlet as described above, the apparatus may have a central outlet that is partitioned into concentric radially inner and outer outlets. In this embodiment, the denser components of the fluid can be directed through the outer outlet and the less dense components of the fluid can be directed through the inner outlet.

A funnel may be provided for channelling the denser components of the fluid and directing it into the outer outlet. In one embodiment, the downstream end of the separator chamber may be funnel-shaped. In another embodiment, a funnel-shaped insert may be provided inside the separator chamber, the funnel-shaped insert being rotatable with the separator chamber. Thus, for example, the funnel-shaped insert may be held within the separator chamber by means of a friction fit, or by adhesive, or one or more mechanical fastening elements or, where the funnel-shaped insert and the separator chamber wall are made of a weldable material, by means of welding.

In one embodiment, a tube or pipe is held within the outlet at the downstream end of the separator chamber such that there is an annular space between the tube or pipe and the wall of the outlet. In this embodiment, the tube or pipe constitutes a first (or inner) fluid outlet and the annular space constitutes the second (or outer) fluid outlet.

The use of concentric outer and inner fluid outlets and a funnel directing fluid containing denser components to the outer outlet has been found to give enhanced separation efficiency.

The term “fluid” as used herein is used in its conventional sense to refer to both liquids and gases.

Thus, the apparatus of the invention can be used to separate mixtures of liquids in a fluid stream and mixtures of solids in a fluid stream as well as mixtures of liquids and solids.

For example, the apparatus can be used to separate:
mixtures of solid particles suspended in a liquid;
mixtures of immiscible liquids (e.g. oil and water);
mixtures of solid particles and liquids suspended in a liquid;
mixtures of gas-entrained solid particles; and
mixtures of one or more gases from a mixture with solids and/or liquids.

The separator chamber is typically tubular in construction and circular in cross-section. However, the interior of the separator chamber may be divergent at an inlet end and convergent at an outlet end (e.g. funnel-shaped at its ends) such that the inlet and/or outlet of the separator chamber are of a reduced diameter compared to the main, central body of the separator chamber. The term “funnel-shaped” as used herein may cover shapes with an increasing/decreasing cross-sectional diameter which increases/decreases at a constant rate. Additionally, the term “funnel-shaped” covers shapes with a cross-sectional diameter which increases/decreases at either an increasing rate or a decreasing rate.

The exterior of the separator chamber is still preferably cylindrical along its entire length. Accordingly, the interior of separator chamber may comprise three sections:
(i) a first section of increasing diameter (preferably increasing at a constant rate);
(ii) a second section of a constant diameter; and
(iii) a third section of a decreasing diameter (preferably decreasing at a constant rate).

It will be appreciated that the reference to “increasing diameter” in (i) refers to an increasing diameter in a downstream direction, i.e. away from the fluid inlet, whereas the reference to “decreasing diameter” in (iii) refers to a decreasing diameter in a downstream direction.

The divergent and/or convergent (e.g. funnel-shaped) ends may be integrally formed as part of the separator chamber or may be formed by affixing angled or appropriately straight or curved guide walls to the interior of the separator chamber.

In one embodiment, the separator chamber is formed in part from a transparent material so that the user can see the extent to which the components of the fluid stream are being separated and can adjust the parameters/settings of the apparatus (e.g. the rotational speed of the separator chamber and/or vortex-creating device and the fluid flow rate through the separator chamber) to maximise the separation efficiency and to control which components of the fluid stream being separated are drawn off through the separator chamber outlet. Alternatively, the separator chamber may be formed from a more hard-wearing material that is more resistant to damage from solid components that are passed through the separator chamber. For example, in some embodiments the separator chamber may be formed from stainless steel. To improve the wear-resistance of the separator chamber, the interior of the separator chamber may be provided with a wear-resistant coating, such as a zinc coating, a titanium coating, a polymeric coating or a carbon-based (e.g. diamond) coating.

In other embodiments, the separator chamber can be formed predominantly of titanium.

The centrifugal separator chamber generally has a longitudinal axis of rotation about which it rotates. The separator chamber may be mounted so that its axis of rotation is substantially vertical, or substantially horizontal, or at an angle between vertical and horizontal. When the separator chamber is mounted so that its axis of rotation is substantially vertical, it may be referred to herein as a vertically mounted separator chamber. Analogously, when the separator chamber is mounted so that its axis of rotation is substantially horizontal, it may be referred to herein as a horizontally mounted separator chamber.

When the separator chamber is tubular in shape and vertically mounted, the separator chamber is mounted such that gravity acts in a direction substantially parallel to the longitudinal axis of the tubular separator chamber. By contrast, when horizontally mounted, gravity acts in a direction substantially orthogonal to the longitudinal axis of the separator chamber. When horizontally mounted, heavy particles may collect along one side of the separator chamber (i.e. the bottom side) as a result of gravity and therefore there may an uneven distribution of material across the cross-section of the separator chamber. Therefore, in some instances, a vertically mounted separator chamber is preferred, as gravity does not cause material to collect along one side of the separator chamber to a greater extent than the other.

When vertically mounted, the fluid inlet may be either at the top or the bottom of the apparatus.

Accordingly, in one general embodiment of the invention, the separator chamber is mounted so that its axis of rotation is substantially horizontal.

In another general embodiment of the invention, the separator chamber is mounted so that its axis of rotation is substantially vertical, and the fluid inlet is located at the top of the apparatus.

In a further general embodiment of the invention, the separator chamber is mounted so that its axis of rotation is substantially vertical, and the fluid inlet is located at the bottom of the apparatus.

The radially inner circumferential surface of the separator chamber may be provided with protrusions to prevent or inhibit heavier material that has accumulated at radially outer regions of the separator chamber from travelling towards the fluid outlet end of the separator chamber. Thereby, only lighter material (which is present towards the centre of the separator chamber) can travel along the entire length of the separator chamber towards the fluid outlet.

The protrusions may take the form of one or more baffles, for example continuous baffle(s) that extend around the entire inner circumference of the separator chamber. When the baffle extends around the entire circumference of the separator chamber, the baffle forms an aperture of a reduced diameter compared to the inner diameter of the separator chamber.

The baffles may be angled, such that they do not extend perpendicularly from the inner circumferential wall of the separator chamber.

The presence of even a single baffle can enhance the ability of the apparatus to separate mixtures of components of differing densities, e.g. mixtures of three or more solid particulate components. In some embodiments, for example when the apparatus is to be used to separate more than two components from a fluid stream, the separator chamber may advantageously be provided with two or more baffles, for example two or more baffles of different heights (i.e. extending different distances from the inner circumference of the separator chamber).

Alternatively, or additionally, the separator chamber may be provided with protrusions (e.g. studs) to break up aggregating material within the separator chamber.

The separator chamber is rotatably mounted on a support structure to allow it to rotate about its longitudinal axis. The separator chamber may be provided with a drive element for rotating the separator chamber. The drive element may comprise a motor (e.g. an electric motor) or a turbine (e.g. a high-pressure air turbine or a hydraulic turbine) and an appropriate mechanical linkage between the motor or turbine and the separator chamber. The mechanical linkage can be, for example, a drive belt. The use of an air turbine or hydraulic turbine is advantageous in environments where it is important to avoid the hazards of electrical spark ignition of explosive gas mixtures (e.g. on oil platforms and similar locations).

The apparatus has an inlet which is connected or connectable to a source of fluid requiring separation. There may be only one such inlet, or there may be present a plurality of openings into the apparatus, each of which constitutes an inlet. The source of fluid requiring separation is pressurised and typically the source of pressure is a pumping arrangement of one or more pumps for pumping the fluid through the inlet into the separator chamber. As an alternative to a pumping arrangement, the pressure may be provided by gravity, e.g. by means of a head of liquid.

The apparatus may further comprise or be associated with a tank comprising the fluid to be separated. The tank typically comprises a submersible pump for pumping the fluid to be separated to the inlet of the apparatus.

When the apparatus is to be used to separate two (or more) solids, the solids are added to the tank along with a carrier liquid (such as water). The tank may also comprise a mixer for creating a suspension of the solids in the carrier liquid.

When the fluid to be separated comprises a fluid with a temperature-dependent viscosity (such as oil), the tank may further comprise a heating element. The heating element can heat the fluid to be separated to reduce its viscosity and thereby change the extent to which centrifugal forces can separate components within the fluid stream.

In one embodiment of the invention, the support structure (a) of the apparatus comprises:
an inlet block which is in fluid communication with the fluid inlet (b); and
an outlet block, which is in fluid communication with the fluid outlet (c);
and the rotatable centrifugal separator chamber extends between and is rotatably mounted on the inlet and outlet blocks;
the inlet block having a rotatable drive shaft extending therethrough and into the separator chamber, the rotatable drive shaft being connected to the vortex-creating device (d) within the rotatable centrifugal separator chamber and being linked at a location externally with regard to the inlet block and the rotatable centrifugal separator chamber to a drive element.

As described in further detail below, as well as extending through the inlet block and into the separator chamber, the rotatable drive shaft may extend from the inlet block, through the entire length of the centrifugal separator chamber and into the outlet block.

The term “block” as used in relation to the “inlet block” and the “outlet block” does not necessarily refer to monolithic integrally formed structures. Whereas the said blocks may each be formed (e.g. by casting and/or machining) from a single piece, they may alternatively be (and more typically are) formed from a plurality of individual pieces.

The inlet block and outer blocks are each typically provided with an external bearing arrangement upon which the rotatable centrifugal separator chamber is mounted, and the inlet block, and optionally also the outlet block, is/are typically provided also with an internal bearing structure for accommodating the rotatable drive shaft.

The internal and external bearings may be of conventional type and will typically contain a plurality of rolling elements such as ball bearings or needle bearings. The bearings, particularly the internal bearing through which the drive shaft passes, are preferably of a type that provide a seal against the passage of liquids such as water or oil.

The rotatable drive shaft may be surrounded by a casing, to protect the drive shaft from erosive effects of the contents of the fluid to be separated in the inlet block. Bearings are typically present within the drive shaft casing to allow the rotatable drive shaft to rotate freely within the casing. The casing is typically tubular in shape and extends through the inlet block.

In some embodiments, the rotatable drive shaft extends into the apparatus through the inlet block and into the centrifugal separation chamber where it terminates.

Alternatively, the rotatable drive shaft may extend through the inlet block, through the centrifugal separation chamber and through the outlet block. In this arrangement, the outlet block is also provided with bearings (as described above) to allow the rotatable drive shaft to rotate within the outlet block.

When the rotatable drive shaft extends through the entire length of the centrifugal separation chamber, the drive shaft may act as an additional outlet for components of the fluid stream being separated by the apparatus. For example, the rotatable drive shaft may be hollow along the whole or part of its length and comprise one of more lateral openings along its length. The rotatable drive shaft can thereby serve as a conduit for components of the fluid stream to exit the apparatus through the lateral openings and along the length of the drive shaft to its end, where a separated component of the fluid stream can be directed into a collector. In this arrangement, the drive shaft acts as a second outlet for the centrifugal separation chamber, for example for the less dense components of the fluid stream.

The apparatus comprises a vortex-creating device for imparting a vortex to the fluid stream. The term ‘vortex’, as used herein, refers to the rotation or revolution of a fluid around an axis (typically a linear axis). The vortex-creating device may therefore be any device that is able to impart such rotation or revolution to the fluid stream. The vortex-creating device is typically located within the separator chamber, usually at the upstream end of the separator chamber.

The vortex-creating device may be an impeller or a propeller. References to an impeller herein can be used interchangeably with the term propeller.

Although the vortex-creating device may be located within the inlet block, the vortex-creating device is typically located within the centrifugal separator chamber.

The vortex-creating device can be positioned at any point on the drive shaft within the separator chamber, as rotation of the vortex-creating device will generate a vortex that extends through substantially the entire length of the separator chamber.

For example, in one embodiment, the vortex-creating device can be positioned at the upstream end of the separator chamber. In another embodiment, the downstream end of the separator chamber. When the centrifugal separator chamber has a variable diameter along its length (e.g. increasing or decreasing internal diameters at its ends), preferably the centre of the vortex-creating device is located in a region of the centrifugal separator chamber with a maximum internal diameter, but typically a part of the vortex-creating device is located in a region of the separator chamber with a reduced internal diameter.

Alternatively, the vortex-creating device may be positioned within the separator tube such that the entire length of the device is located within the separator chamber in the region having a maximum internal diameter.

The vortex-creating device typically comprises a number of (e.g. two, three, four, or five, preferably at least three) blades which are angled to generate a vortex in a fluid when rotating.

The blades may be angled at an angle of from 1° to 90°, more usually from 10° to 60°, for example from 15° to 50°, such as approximately 22.5° or approximately 45°, with respect to the longitudinal direction of the separator chamber.

Alternatively, the vortex-creating device may take the form of a rotating body having surface formations shaped so as to create a vortex as the rotating body is rotated. The rotating body may be substantially cylindrical in shape, but typically has relatively smaller diameters at upstream and downstream ends thereof and a relatively larger diameter at a location between the upstream and downstream ends. For example, the rotating body may be a substantially barrel-shaped body. The barrel-shaped body typically has a larger diameter at its centre compared to its ends. The body may comprise a number (e.g. four, six or eight) channels along the length of the barrel, preferably spaced equally around its circumference. The channels may be angled or parallel with respect to the longitudinal axis of the body. A series of ridges which function as shallow vanes may therefore be defined by the spaces between the channels and rotation of these vanes provides a vortex-creating effect.

The vortex-creating device (e.g. impeller or propeller) is typically connected to a drive element for rotating the vortex-creating device. The drive element is typically different to the drive element used to control rotation of the centrifugal separation chamber, in order to allow independent rotation of the centrifugal separation chamber and the vortex-creating device. The drive element may comprise a motor (e.g. an electric motor) or a turbine (e.g. a high-pressure air turbine or a hydraulic turbine) and an appropriate mechanical linkage (e.g. a drive shaft as defined herein) between the motor or turbine and the vortex-creating device. The mechanical linkage can be, for example, a drive belt.

The vortex-creating device (e.g. the impeller) is controllable so as to create vortices of varying strengths, e.g. by increasing or reducing the speed of rotation of the vortex-creating device.

The fluid inlet (a) may advantageously be configured to impart a degree of twist to the fluid stream as it enters the centrifugal separator chamber, thereby assisting in establishment of the vortex. Thus, for example the fluid inlet may comprise one or more inlet channels that are configured and oriented so that the fluid stream enters the centrifugal separator chamber at a peripheral location and at an angle with respect to the longitudinal axis of the centrifugal separator chamber. The fluid inlets may be angled at an angle of from 1° to 90°, more usually from 10° to 60°, for example from 15° to 50°, such as approximately 22.5° or approximately 45°, with respect to the longitudinal direction of the separator chamber.

As a result of the centrifugal forces imparted by the vortex-creating device, the fluid to be separated passes through the separator chamber, and the higher density components of the fluid stream move outwardly towards the periphery of the separator chamber to a greater extent than the lower density components thereby resulting in separation of the higher and lower density components.

At the downstream end of the separator chamber, there is an outlet for collecting separated components of the fluid stream. As described above, there may be only a single outlet or there may be two outlets (for example, two concentric tubes). In some embodiments where the drive shaft also acts as a fluid outlet, there may be two outlets. When two outlets are present, it will be appreciated that less dense components of the fluid stream will exit the apparatus via the radially inner rotatable drive shaft, whereas a radially outer opening is provided at the end of the separator chamber for collecting the more dense components.

The outlet(s) is/are preferably centrally located on the axis of the separator chamber and may be coaxial with the axis of rotation of the separator chamber. The outlet may also have a convergent wall or walls to facilitate collection of the separated components of the fluid stream. The outlet is preferably located at or near the opposite end of the separator chamber to the inlet. Thus, for example, the outlet may take the form of a conical funnel. The convergent wall or walls (e.g. a conical funnel) may be fitted to the downstream end of the separator chamber or the outlet block. Alternatively, the interior of the downstream end of the separator chamber may be shaped to provide a convergent wall or walls (e.g. to form a conical funnel) in order to direct fluid from the separator chamber to the outlet(s) or outlet block.

In an embodiment of the invention, there is provided an apparatus for separating components of a fluid stream, the apparatus comprising:
(a) a support structure on which is mounted a rotatable centrifugal separator in which separation of the components of the fluid stream occurs, wherein the centrifugal separator chamber has a longitudinal axis of rotation about which it rotates;
(b) a fluid inlet for introducing a pressurised source of the fluid stream to be separated into the centrifugal separator chamber;
(c) a fluid outlet for collecting one or more separated components of the fluid stream, wherein the fluid outlet is coaxial with the axis of rotation of the centrifugal separator chamber;
(d) a vortex-creating device which rotates in order to introduce a vortex to the fluid stream in the centrifugal separation chamber thereby to bring about centrifugal separation of the components of the fluid stream;
and wherein the centrifugal separator chamber and vortex-creating device are configured to rotate independently of each other.

The outlet(s) may be connected or connectable to one or more collectors for collecting separated components of the fluid stream. When only one outlet is present but two or more collectors are present, the outlet may comprise a valve or diverter for diverting the output of the separator chamber to a selected collector or collectors.

The separator chamber may be made from metals, plastics materials or other durable materials or combinations thereof. In one embodiment, the separator chamber comprises a separator chamber formed from an acrylic plastics material, the separator chamber being connected between a pair of end structures typically formed from metal materials, wherein the end structures are rotatably mounted on the support structure (a). In another embodiment, the separator chamber is made from stainless steel.

The apparatus described herein may be configured to enable it to carry out a particular type of separation.

In one embodiment, the separation apparatus can be configured to separate a mixture of two or more solids of differing densities. For example, the separator can be configured to separate metal (and in particular heavy metals, such as gold) from silt/sand/grit. The solids to be separated is mixed with a liquid (preferably water) to form a fluid stream of the solids which can then be fed through the apparatus described herein.

It will be appreciated that the extent of separation of the components of the fluid stream will typically depend on the geometry of the separator chamber and speed of rotation of the vortex-creating device. An apparatus intended to be used to separate components of a fluid a more similar density may require a larger separator chamber (e.g. a tubular separator chamber with a larger diameter) and/or a higher vortex-creating device rotation speed.

The invention further provides a method for separating components of a fluid stream, the method comprising passing the fluid stream through an apparatus as described herein.

The invention also provides a method for separating components of a fluid stream, the method comprising passing the fluid stream through an apparatus as described herein, controlling the fluid flow rate through the separator chamber, the speed of rotation of the separator chamber and the speed of rotation of the vortex-creating device to hold a heavier fraction of the fluid stream components within the separator chamber while allowing a lighter fraction to pass through to the fluid outlet to a collector; and then adjusting one or more of the fluid flow rate through the separator chamber, the speed of rotation of the separator chamber and the speed of rotation of the vortex-creating device to cause the heavier fraction to pass through to the fluid outlet to a collector.

As will be appreciated, the fluid flow rate through the apparatus, the separator chamber rotation speed and the vortex-creating device rotation speed may all be adjusted to optimise the separation efficiency of the apparatus for a given fluid to be separated. This adjustment/optimisation can be done manually or through use of an electronic controller, which is able to retrieve flow rates and rotation speeds for a given fluid to be separated from an electronic storage device.

Accordingly, the apparatus may also comprise:
i) an electronic controller, for controlling one or more of:
   a. the flow rate of the fluid through the apparatus (e.g. the pumping pressure of the submersible pump);
   b. the rotation speed of the vortex-creating device (e.g. the speed of motor associated with/connected to the vortex-creating device, via the rotatable drive shaft); and
   c. the rotation speed of the separator chamber (e.g. the speed of motor associated with/connected to the separator chamber) and optionally:
ii) an electronic storage device in communication with the electronic controller which contains a list of fluids that can be separated along with associated flow rates, vortex-creating device rotation speeds and separator chamber rotation speeds; and/or
iii) a user interface through which the user can indicate to the electronic controller the fluid to be separated (and therefore the data the electronic controller needs to receive from the electronic storage device).

It will be appreciated that the flow rate and rotation speeds may be varied during the separation process. The electronic storage device may therefore store data relating to a programme of flow rates and rotation speeds over different time periods.

The apparatus may be further provided with one or more sensors in communication with the electronic controller for detecting the presence and position of particles within the separator chamber. The electronic controller can then adjust the flow rate and rotation speeds based on the inputs from the sensors.

The invention also provides a method for separating a mixture of different types of particles contained in a solid mixture, wherein the different types of particles have differing densities, the method comprising:
a) forming a suspension of the solid mixture by adding the solid mixture to a carrier liquid (e.g. water or an oil); and
b) passing the suspension as a fluid stream through an apparatus as described herein; and
c) separating the different types of particles according to their densities by controlling the fluid flow rate through the separator chamber, the speed of rotation of the separator chamber and the speed of rotation of the vortex-creating device as defined herein.

The solid mixture may be added to the carrier liquid in an amount of from 10% to 25% by weight (for example, from 15% to 20% by weight) in order to form a suspension which is sufficiently fluid to pass through the apparatus without causing an obstruction within the apparatus.

The apparatus can also be used to separate solids having different densities. In order to separate solids of different densities in a mixture, a suspension of the solid mixture in a fluid such as water is first formed and is then separated by passing the suspension through the apparatus.

The apparatus can be used to separate a wide range of different solid particulate substances. For example, in one embodiment, the apparatus can be used to separate metal particles (for example gold or other precious metals) from other particulates such as sand and grit.

In another embodiment, the apparatus can be used to fractionate mineral particulates such as sands, grit and pulverised rocks in order to isolate mineral particulates of particular interest such as metal ores or sources of rare earth elements.

In a further embodiment, the apparatus can be used to separate mixtures of liquids; for example a suspension of one liquid (e.g. oil) in an immiscible liquid (e.g. water).

In a further embodiment, the apparatus can be used to separate gases from liquids; for example from a suspension of a gas in a liquid.

The invention will now be illustrated in more detail (but not limited) by reference to the specific embodiments shown in the accompanying drawings.

### BRIEF DESCRIPTION OF THE DRAWINGS

FIG. 1 is a schematic side view showing an apparatus according to one embodiment of the invention.

FIG. 2 is a cross-sectional schematic view of the apparatus shown in FIG. 1.

FIG. 3 is a simplified schematic diagram showing the presence of different fluid streams in the separator chamber during operation.

FIG. 4 is a photograph of an upstream T-connector which can be used in the apparatus of FIGS. 1 and 2.

FIG. 5 is a photograph of a downstream T-connector which can be used in the apparatus of FIGS. 1 and 2.

FIG. 6 is a photograph from one side of an apparatus according to the invention.

FIGS. 7A and 7B show possible configurations of guide channels within the T-connectors for channelling fluid through to the separator chamber.

FIG. 8 is a schematic side view showing an apparatus according to a second embodiment of the invention.

FIG. 9 is a cross-sectional schematic view of the apparatus shown in FIG. 8.

FIG. 10 is a schematic side view showing an apparatus with a shorted separation tube according to a third embodiment of the invention.

FIG. 11 is a photograph of a side view of an apparatus corresponding to the schematic view shown in FIG. 8, but wherein the impeller is located at the upstream end of the separator tube rather than the downstream end.

FIG. 12 is a photograph of a side view of an apparatus corresponding to the schematic view shown in FIG. 10.

FIG. 13 is a schematic side view showing a vertically mounted apparatus according to a fourth embodiment of the invention.

FIG. 14 is a photograph of a side view of an apparatus corresponding to the schematic view shown in FIG. 13.

FIG. 15 is a cross-sectional schematic view of an apparatus according to a fifth embodiment of the invention.

### DETAILED DESCRIPTION OF THE INVENTION

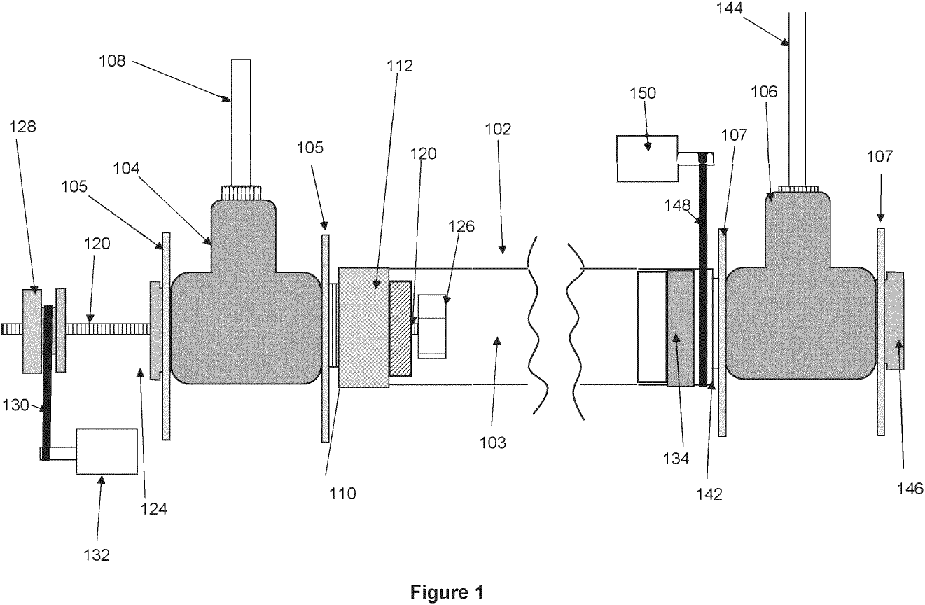

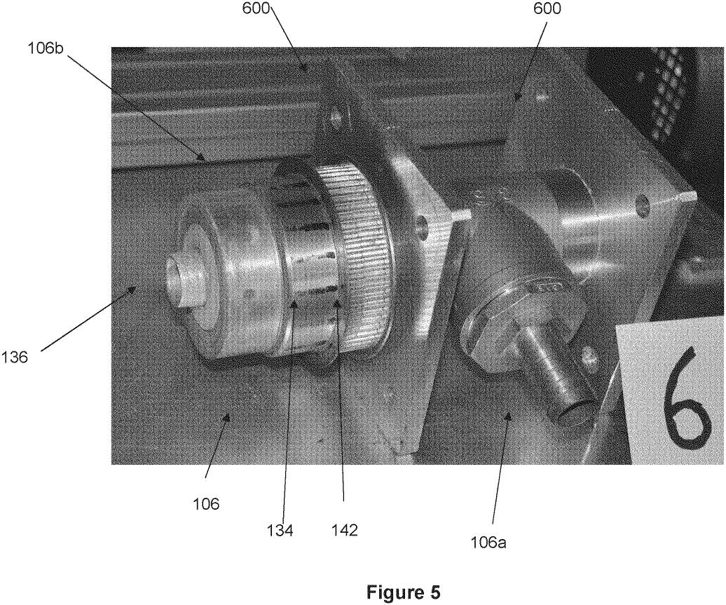

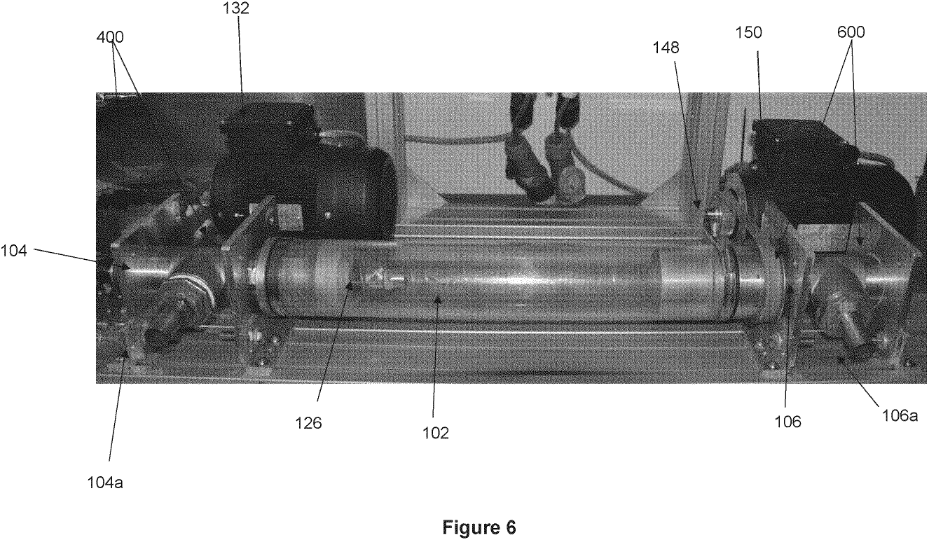

### First Embodiment - FIGS. 1 to 7B

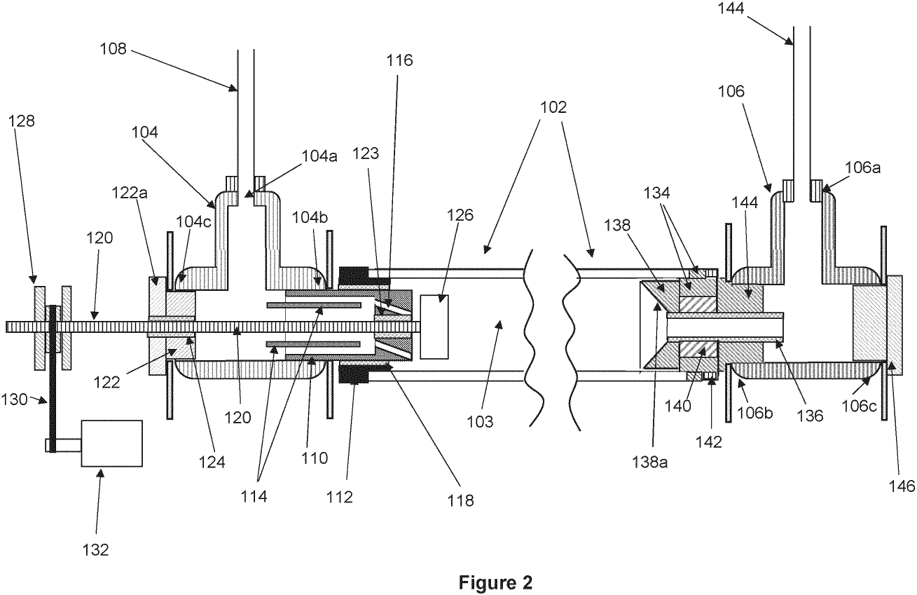

An apparatus according to a first embodiment of the invention is illustrated schematically in FIGS. 1 and 2.

The apparatus of FIGS. 1 and 2 can be used to separate two or more different solid particulate components in a suspension (e.g. an aqueous suspension).

The apparatus comprises a separator chamber (102) rotatably mounted between an upstream T-connector (104) and a downstream T-connector (106). Each T-connector (104, 106) has three openings - two coaxial longitudinal openings (104b, 104c / 106b, 106c) and a perpendicular lateral opening (104a / 106a).

The separator chamber (102) comprises a transparent tube (103) formed from an acrylic plastics material mounted at each end thereof on cylindrical end formations (112) and (134). The upstream end formation (112) is rotatably connected to the upstream T-connector (104) and the downstream end formation (134) is rotatably connected to the downstream T-connector (106).

The use of a transparent tube (103) for the separator chamber (102) allows the user to visualise the separation of components of the suspension to be separated within the tube (103) and enables the user to gauge the effect of altering the operating conditions of the apparatus on the separation.

The transparent tube (103) of the separator chamber (102) may be provided on its inner surface with baffles or protrusions (not shown) to prevent solid material that has aggregated at the radially outer regions of the separator chamber from travelling along the separator chamber (102) to its outlet end.

Rotation of the separator chamber (102) is driven by a first drive belt (148) and a first motor (150). The drive belt and motor are shown in FIG. 1 but are not shown in FIG. 2.

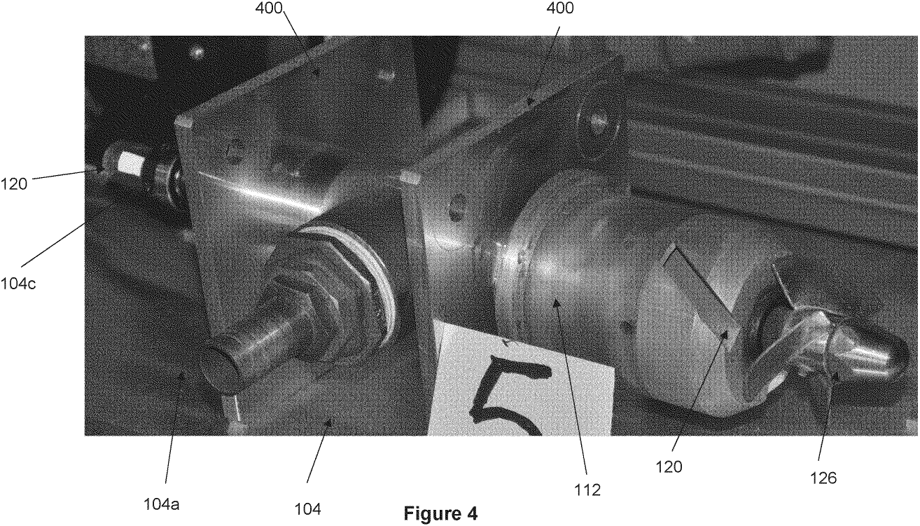

Each T-connector (104, 106) has a pair of coaxial longitudinally aligned end openings and a perpendicular (with respect to the longitudinal openings) lateral opening. The lateral openings serve as the connector inlets or outlets. The T-connectors (104, 106) are each mounted between pairs of metal plates ((105) and (107) in FIGS. 1 and 2 and (400) and (600) in the embodiment of FIGS. 4, 5 and 6), with the longitudinal openings communicating with apertures in the metallic plates. The openings of the T-connectors (104, 106) are internally threaded to allow connection with other components of the apparatus.

The lateral opening (104a) on the upstream T-connector is connected by means of its internal thread to an externally threaded end of a connector member (108) which in turn is connected via a length of tubing (not shown) to a pumped source of the suspension to be separated. The lateral opening (104a) on the upstream T-connector therefore serves as a fluid inlet.

The connector member (108) attached to the lateral opening (104a) is connected via a length of plastic tubing to a pump (not shown) submerged within a tank containing the suspension to be separated. When the pump is turned on, the suspension is pumped from the tank to the upstream T-connector (104) of the apparatus. The tank may also comprise a mixer for agitating the suspension to maintain the particulates in a suspended state.

Secured within a first end opening (104b) of the upstream T-connector (104) is a connector piece (110) through which fluid exits the upstream T-connector (104) and into the separator chamber (102). The connector piece is partially threaded around its outer surface on its upstream end to enable it to be connected to a corresponding thread formed within the first end opening (104b) of the upstream T-connector (104).

The connector piece (110) is formed from a metallic cylinder into which a circular bore has been machined through part of its length leaving a downstream end wall having a circular hole therein. Secured within the circular hole is an oil seal bearing (123), through which rotating drive shaft (120) extends. The oil seal bearing (123) allows the rotating drive shaft (120) to rotate within the connector piece while preventing fluid leakage around the drive shaft.

The downstream end wall of the connector piece (110) is also provided with a number of angled channels (116) which originate at openings on an upstream side of the wall and terminate at openings around the circumference of the connector piece (110). As fluid exits the connector piece (110) it passes through the angled channels (116) such that rotation is imparted to the fluid as it enters the separator chamber (102).

The cylindrical end formation (112), which has a stepped outer surface, is mounted on the connector piece (110) and an oil seal bearing assembly (118) is provided between the connector piece and the cylindrical end formation (112) so that the cylindrical end formation (112) can rotate freely around the connector piece. The transparent tube (103) of the separator chamber (102) is secured about the cylindrical end formation (112) to provide a fluid-tight seal (e.g. by means of a sealing gasket or O-ring - not shown) between confronting surfaces of the two components. Thus, the separator chamber (102) is able to rotate freely around the connector piece (110).

The suspension to be separated enters the apparatus via the upstream T-connector (104) and passes through a series of parallel channels. Within the upstream T-connector there are a number of guide walls (114) which define the parallel channels. The guide walls (114) may be made from a metal or plastics material, which is sufficiently rigid so as not to deform as the suspension passes through the upstream T-connector.

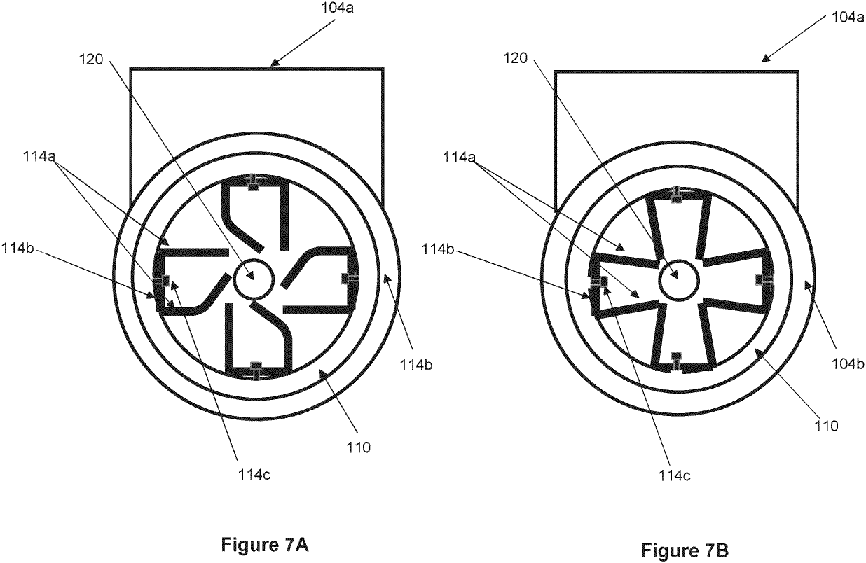

An example of the arrangement of the guide walls (114) within the upstream T-connector (104) is shown schematically in FIG. 7A.

The guide walls (114) have a substantially U-shaped cross-section and have a base portion (114b) and two substantially perpendicular arms or side walls (114a) at each side of the base portion. One of the arms (114a) of each guide wall is bent to provide clearance for the rotating drive shaft (120). The two arms or side walls (114a) and the base (114b) define a channel with an open side, which faces away from the interior wall of the connector piece (110). The guide walls are attached (for example, by means of screws/rivets (114c)) to the interior wall of connector piece (110) equidistantly around its inner circumference.

An alternative arrangement of the guide walls (114) is shown in FIG. 7B.

In this arrangement, the guide walls (114) have a substantially U-shaped cross-section and have a base portion (114b) and two converging arms or side walls (114a) at each side of the base portion. The two arms (114a) and the base (114b) define a channel with an open side, which faces the centre of the connector piece (110). The guide walls are attached (for example, by means of screws/rivets (114c)) to the interior wall of connector piece (110) equidistantly around its inner circumference.

In FIGS. 7A and 7B, screws/rivets (114c) are used to secure the guide walls to the interior of the connector piece (110). However, it will be appreciated that in practice, the screws/rivets may be countersunk into the connector piece (110) in order to further reduce the turbulence of the suspension passing through the connector piece (110). Alternatively, the guide walls can be fixed to the interior wall of the connector piece using other fastenings/adhesives.

The guide walls (114) are arranged so as to provide a central space through which the drive shaft (120) can pass (as shown in FIGS. 7A and 7B).

The guide walls (114) collimate the fluid prior to separation in order to reduce turbulence in the fluid and thereby increase separation efficiency.

A second longitudinal opening (104c) of the upstream T-connector (which is positioned opposite the longitudinal opening 104b) is sealed with an externally threaded plug (122), the flange (122a) of which holds the T-connector in place against the metal plate (105). The plug (122) also has a central bore, fitted with an oil seal bearing (124) through which the threaded drive shaft (120) passes. The drive shaft (120) is thus able to rotate within the plug (122).

The drive shaft (120) passes from the outside of the upstream T-connector, through the plug (122) and upstream T-connector (104) and into the separator chamber (102). At the end of the shaft located inside the separator chamber (102), the impeller (126) is non-rotatably mounted on the drive shaft.

The impeller (126) has a central hub with a plurality of blades (e.g. three) radiating outwardly from the hub, at an angle of approximately 22.5°. The hub also has a threaded central hole to allow the impeller (126) to be secured to the correspondingly threaded end of the drive shaft (120).

At an end of the shaft which protrudes from the plug (122), a pulley wheel (128) is non-rotatably mounted on the shaft. The pulley wheel (128) has a circumferential groove for accommodating a drive belt (130). The drive belt (130) is connected to an electric motor (132) and the motor can thereby drive rotation of the drive shaft (120) and the impeller (126). The impeller (126) may be rotated in the same or an opposite direction to the direction in which the separator chamber (102) rotates.

The downstream end of the transparent tube (103) of the separator chamber (102) is attached to downstream end formation (134) which is in the form of a collar. The collar (134) has a stepped outer surface and a sealing gasket (e.g. an O-ring seal) (not shown) is located between axially facing confronting surfaces of the collar (134) to provide a fluid-tight seal therebetween.

The collar (134) is rotatably mounted on an oil seal bearing assembly (140) which in turn is mounted on a fixed non-rotatable central collector tube (136).

The collar (134) is provided with a ribbed/grooved section (142) around its circumference, which can engage with a second drive belt (148) powered by a second motor (150) which drives rotation of the collar (134) and thereby rotates the separator chamber (102). The drive belt (148) and motor (150) are shown in FIG. 1 but are not shown in FIG. 2.

The collector tube (136) is fixedly secured within a central bore of a plug (144) which is fastened within the opening (106b) of the T-connector (106) by means of an external thread which engages an internal thread in opening (106b).

A funnel collector (138) is mounted on the inner end of the collector tube (136). The funnel collector (138) has a generally conical surface (138a) which converges towards the opening of the collector tube (136).

The other longitudinal opening (106c) of the downstream T-connector (106) is internally threaded and is sealed with a second plug (146) which has an externally threaded spigot portion and a hexagonal flange for use in tightening the plug into the opening (106c).

In operation, fluid containing components to be separated is pumped through the inlet (104a) in the T-connector (104), and into the separator chamber (102) via the angled channels (116). The angled channels impart a degree of rotation to the stream of fluid entering the separator chamber (102). The drive motor (132) is then switched on and the drive shaft (120) rotates, thereby to rotate the impeller (126). The spinning impeller imparts further rotation to the fluid stream so that the fluid forms a vortex in the separator chamber (102). Due to the centrifugal forces created by the vortex operating on the components of the fluid, as the vortexed fluid stream passes through the separator chamber (102) the denser component(s) of the fluid are forced to the outer regions of the separator chamber, whilst less dense components follow a path closer to the longitudinal axis of the separator chamber. Once a vortex has been created, the drive motor (150) is switched on so that the drive belt (148) drives rotation of the separator chamber. The rotation can be either in the same direction as the impeller or the opposing direction.

As the fluid travels down the separator chamber (102), the centrifugal forces acting upon it leads to separation of the components of the fluid according to their densities. By selecting an appropriate impeller speed, an appropriate direction and speed of rotation of the separator chamber, and an appropriate flow rate, the denser component(s) of the suspension can be made to accumulate and remain at the outer regions of the separator chamber (102) whilst the less dense component(s) pass along the inner regions of the separator chamber (102).

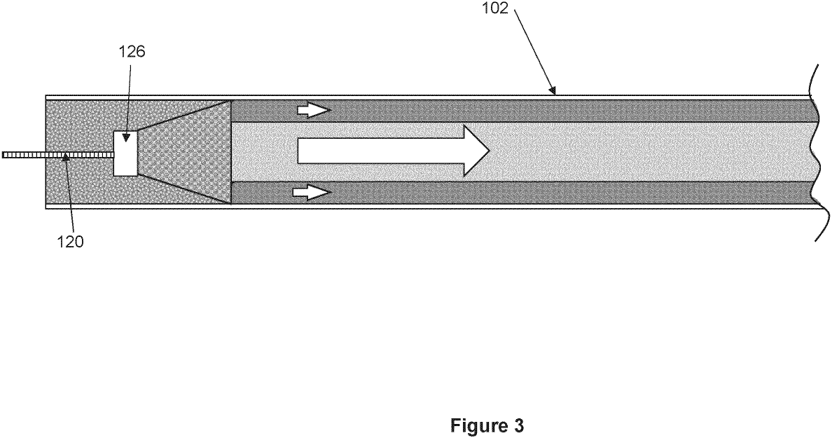

Without wishing to be bound by theory, it is thought that due to the central position of the impeller, fluid at the centre of the separator chamber (102) moves faster than fluid at the radially outer regions of the separator chamber (102) (i.e. at or near the walls of the separator chamber). Rotation of the separator chamber (102) causes the heavier components of the fluid stream to collect/reside at or near the walls of the separator chamber. Therefore, due to the differing fluid velocities within the separator chamber, the lighter component of the fluid stream travels along the length of the separator chamber (102) towards its outlet at a relatively high velocity, while the heavier component of the fluid stream travels at a much lower velocity along the separator chamber and instead resides at or near the separator chamber walls. This is shown schematically in FIG. 3. The rotation speeds of the impeller and separator chamber can be adjusted to vary the density of the components in the central fluid stream which are directed to the separator chamber outlet.

At the downstream end of the separator chamber, the fluid containing the lighter components is collected by the funnel collector (138) and funnelled into the collector tube (136), from where it passes into the downstream T-connector (106) and through an exit pipe (144) which may lead to a collector for collecting separated components of the fluid stream.

Once the lighter components of the fluid stream have been collected, the relative speeds of rotation of the impeller and/or separator chamber and/or the pumped flow rate of the fluid through the chamber can be changed so that the denser components of the fluid move inwards towards the axis of the separator chamber and are collected through the funnel collector and collector tube.

The exit pipe (144) may be provided with a valve (not shown) which can be opened or closed to control release of the separated fluid components from the apparatus. Alternatively, the exit pipe (144) may be provided with a three-way valve so that components collected by the separator can be directed into one of two collectors.

The “appropriate” speeds and flow rates for separating a given mixture can be determined empirically by trial and error. Because the separator chamber is at least partially transparent, it is possible to see denser particles accumulating at the periphery of the separator chamber and hence it is possible to judge visually when the separation is complete and hence when to collect the lighter components of the fluid before changing the conditions to collect the denser components.

The apparatus can be used to separate multicomponent mixtures by varying the impeller and separator rotation speeds and the fluid flow rate as described above. For example, to separate a three-component mixture, the rotation speeds and flow rates can be set up to enable collection of a first lighter fraction initially while allowing two heavier fractions to accumulate at the periphery of the separator chamber. Once the lighter component has been collected, the two denser components can be collected and recycled through the apparatus and the rotation speeds and flow rate adjusted so to separate the two denser components from each other.

By placing a baffle (not shown) in the separator chamber, the efficiency of the separation process can be improved still further, as the baffle will assist in retarding movement of denser fractions along the separator chamber.

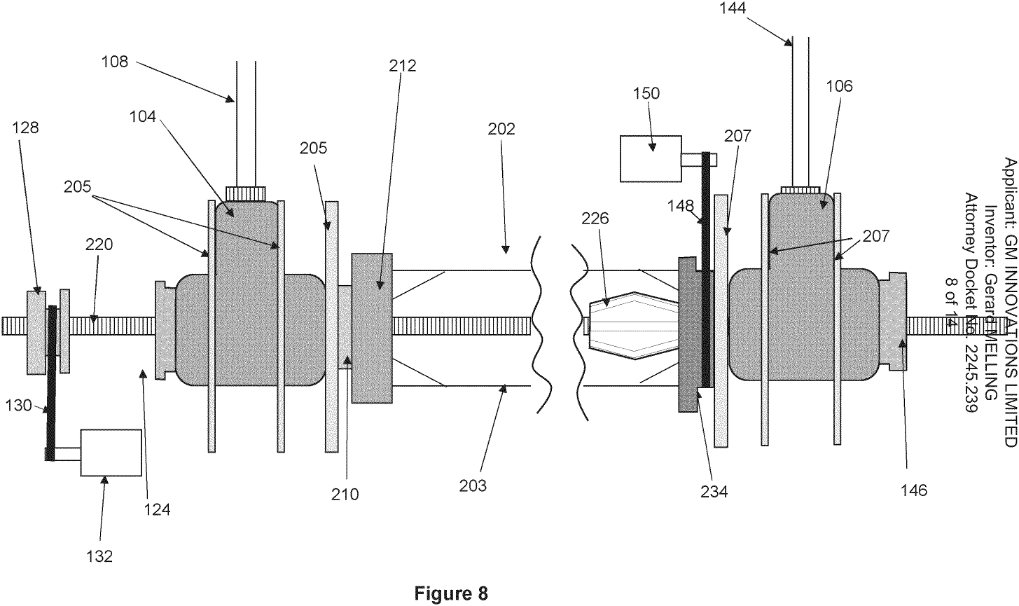

### Second and Third Embodiment - FIGS. 8 to 12

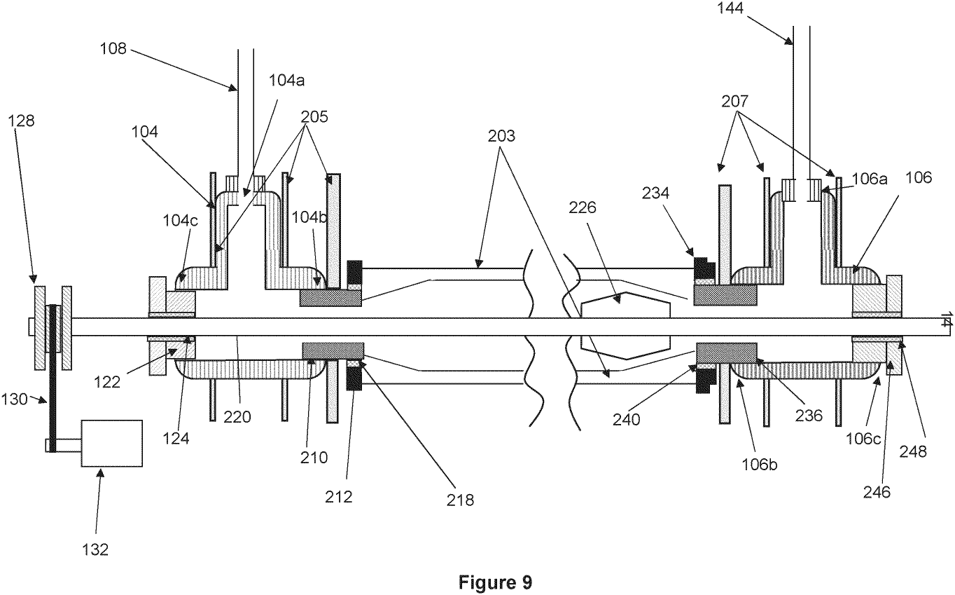

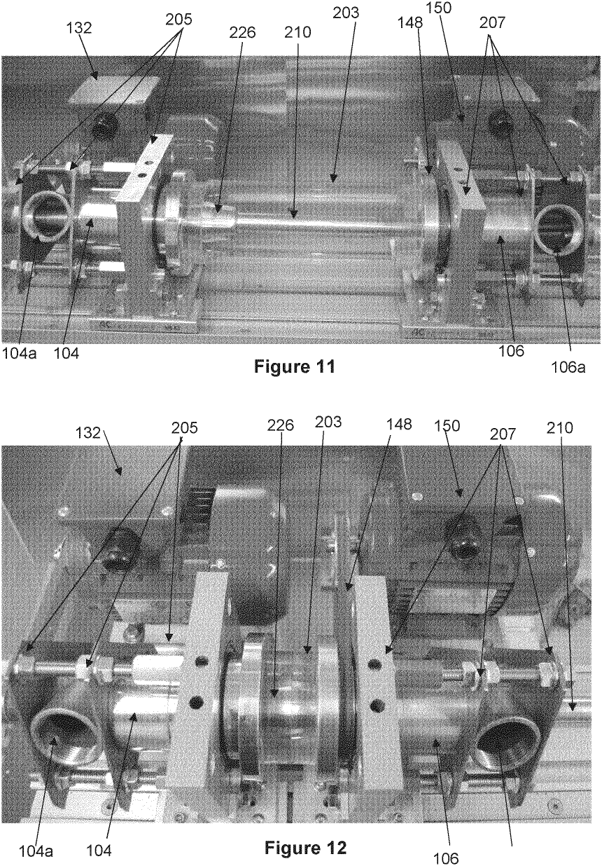

An apparatus according to a second embodiment of the invention is illustrated schematically in FIGS. 8 and 9. A photograph of an apparatus corresponding to these figures is provided as FIG. 11.

Unless otherwise specified, components labelled with the same reference numerals used in FIGS. 1 to 7B correspond to the features present in the first embodiment described above.

The apparatus of FIGS. 8 and 9 can be used to separate two or more different solid particulate components in a suspension (e.g. an aqueous suspension).

The apparatus comprises a separator chamber (202) rotatably mounted between an upstream T-connector (104) and a downstream T-connector (106). Each T-connector has three openings - two coaxial longitudinal openings (104b, 104c / 106b, 106c) and a perpendicular lateral opening (104a/106a).

The separator chamber (202) comprises a transparent tube (203) formed from an acrylic plastics material mounted at each end thereof on rotating end formations (212) and (234). The upstream end formation (212) is rotatably connected to the upstream T-connector (104) and the downstream end formation (234) is rotatably connected to the downstream T-connector (106) via the first and second connector pieces (210, 236) respectively through bearings (218, 240).

The transparent tube (203) has a cylindrical exterior. The central part of the transparent tube (203) is tubular with a bore of a constant cross-section extending through the tube. However, the interiors of upstream and downstream ends of the transparent tube are funnel-shaped (as can be seen in FIG. 9). At the downstream end of the transparent tube (103), the interior funnel shape serves to guide fluid to the outlets of the transparent tube (203), namely the channels in the second connector piece (236).

The transparent tube (203) of the separator chamber (202) may be provided on its inner surface with baffles or protrusions (not shown).

Rotation of the separator chamber (202) is driven by a first drive belt (148) and a first motor (150). The drive belt and motor are shown in FIG. 8 but are not shown in FIG. 9.

Each T-connector (104, 106) has a pair of coaxial longitudinally aligned end openings and a perpendicular (with respect to the longitudinal openings) lateral opening. The lateral openings serve as the connector inlets or outlets. Each T-connector (104, 106) is each mounted between three metal plates (205, 207), with the longitudinal openings communicating with apertures in the metallic plates. The openings of the T-connectors (104, 106) are internally threaded to allow connection with other components of the apparatus.

The lateral opening (104a) on the upstream T-connector is connected by means of its internal thread to an externally threaded end of a connector member (108) which in turn is connected via a length of tubing (not shown) to a pumped source of the suspension to be separated. The connector member (108) attached to the lateral opening (104a) is connected via a length of plastic tubing to a pump (not shown) submerged within a tank containing the suspension to be separated. The tank may also comprise a mixer for agitating the suspension to maintain the particulates in a suspended state.

Secured within a first end opening (104b) of the upstream T-connector (104) is a first connector piece (210) through which fluid exits the upstream T-connector (104) and into the separator chamber (102). The first connector piece is partially threaded around its outer surface on its upstream end to enable it to be connected to a corresponding thread formed within the first end opening (104b) of the upstream T-connector (104).

The first connector piece (210) is metallic and tubular. The exterior of the connector piece is threaded at both ends to allow connection with the first end opening of the upstream T-connector (104b) and the rotating upstream cylindrical end formation (212).

The rotating upstream cylindrical end formation (212) is mounted on the first connector piece (210) and an oil seal bearing assembly (218) is provided between the first connector piece and the cylindrical end formation (212) so that it can rotate freely around the first connector piece. The cylindrical end formation (212) comprises a flange around which the separator tube (203) fits to form a fluid-tight interference fit. Thus, the separator chamber (202) is able to rotate freely around the first connector piece (210).

A second longitudinal opening (104c) of the upstream T-connector (which is positioned opposite the longitudinal opening 104b) is sealed with an externally threaded plug (122). The plug (122) also has a central bore, fitted with an oil seal bearing (124) through which the threaded drive shaft (220) passes. The drive shaft (220) is thus able to rotate within the plug (122).

At an upstream end of the shaft which protrudes from the plug (122) in the upstream T-connector, a pulley wheel (128) is non-rotatably mounted on the shaft. The pulley wheel (128) has a circumferential groove for accommodating a drive belt (130). The drive belt (130) is connected to an electric motor (132) and the motor can thereby drive rotation of the drive shaft (220) and the impeller (226). The impeller (226) may be rotated in the same or an opposite direction to the direction in which the separator chamber (202) rotates.

Secured within a first end opening (106b) of the downstream T-connector (106) is a second connector piece (236) through which fluid exits the separator chamber (202) and into the downstream T-connector (104). In a similar manner to the first connector piece (210), the second connector piece (236) is partially threaded around its outer surface on its upstream end to enable it to be connected to a corresponding thread formed within the first end opening (106b) of the downstream T-connector (106).

Like the first connector piece (210), the second connector piece (236) is metallic and tubular in shape.

The downstream end of the transparent tube (203) of the separator chamber (202) is secured to the downstream end formation (234). The downstream end formation comprises a stepped collar. The downstream end formation (234) is rotatably mounted on an oil seal bearing assembly (240) which in turn is mounted on the fixed non-rotatable second connector piece (236).

A portion of the downstream end formation (234), specifically the lower stepped portion is provided with a ribbed/grooved section around its circumference, which can engage with a second drive belt (148) powered by a second motor (150) which drives rotation of the downstream end formation (234) and thereby rotates the separator chamber (202). The drive belt (148) and motor (150) are shown in FIG. 8 but are not shown in FIG. 9.

The other longitudinal opening (106c) of the downstream T-connector (106) is internally threaded and is sealed with the second plug (246) which has an externally threaded spigot portion and a hexagonal flange for use in tightening the plug into the opening (106c). The plug contains a central bore provided with bearing (248) through which the end of the drive shaft (220) passes. The drive shaft is freely rotatable within the plug. As mentioned above, the drive shaft (220) can be used to collect low density material from the separator chamber (202). The drive shaft can therefore be provided with a hole at its end to allow the collected less dense material to exit the apparatus. The end of the drive shaft (220) may be provided with or connectable to a collector to collect separated material exiting out of the end of the drive shaft (220).

The drive shaft (220) passes through the upstream T-connector (104), separator chamber (102) and downstream T-connector (106). At the upstream T-connector side, the drive shaft (220) passes from the outside of the upstream T-connector, through the plug (122) and upstream T-connector (104) and into the separator chamber (102). The drive shaft then passes through the entire length of the transparent tube (103) of the separator chamber (102) and then passes through the downstream T-connector (106) and exits the downstream T-connector through a central bore (fitted with an oil seal bearing, (248)) in a second plug (246).

The drive shaft (220) may be hollow along the whole or part of its length and can be provided with holes along its length to act as a further fluid outlet for the device.

Material of lower density which, during operation of the device, collects at radially inward locations of the separator chamber (202) near the drive shaft (220) can exit the apparatus through the holes in the drive shaft, along the length of the drive shaft and through the plug (246) of the downstream T-connector. This arrangement is useful for the drive shaft to act as an outlet for particularly light components within the fluid stream (for example, gases).

On the shaft within the separator chamber (202), the impeller (226) is non-rotatably mounted on the drive shaft. In this embodiment, as shown in FIGS. 8 and 9, the impeller (226) is mounted on the draft shaft at the downstream end of the separator tube (203).

The impeller (226) has a barrel-shaped body with a maximum diameter at its centre and diameters decreasing at equal rates from the centre to the end of the barrel. Along the length of the barrel-shaped body are six channels formed by grooves or recesses along the body in an orientation parallel to the longitudinal axis to the barrel-shaped body.

The body also has a threaded central hole to allow the impeller (226) to be secured to the correspondingly threaded end of the drive shaft (220).

In operation, fluid containing components to be separated is pumped through the inlet (104a) in the T-connector (104), and into the separator chamber (102). The drive motor (132) is then switched on and the drive shaft (120) rotates, thereby to rotate the impeller (226). The spinning impeller imparts further rotation to the fluid stream so that the fluid forms a vortex in the separator chamber (102). Due to the centrifugal forces created by the vortex operating on the components of the fluid, as the vortexed fluid stream passes through the separator chamber (102) the denser component(s) of the fluid are forced to the outer regions of the separator chamber, whilst less dense components follow a path closer to the longitudinal axis of the separator chamber. Once a vortex has been created, the drive motor (150) is switched on so that the drive belt (148) drives rotation of the separator chamber. The rotation can be either in the same direction as the impeller or the opposing direction.

The manner of separation is therefore the same as described above in relation to the first embodiment shown in FIGS. 1 to 7B.

At the downstream end of the separator chamber, lighter components are funnelled to the exit of the separator chamber by virtue of the internal shape of the transparent tube (103). The fluid passes through the channels in the second connector piece (236) and continues into the downstream T-connector (106) and through an exit pipe (144) which may lead to a collector for collecting separated components of the fluid stream.

Once the lighter components of the fluid stream have been collected, the relative speeds of rotation of the impeller and/or separator chamber and/or the pumped flow rate of the fluid through the chamber can be changed so that the denser components of the fluid move inwards towards the axis of the separator chamber and are collected through the funnel collector and collector tube.

The exit pipe (144) may be provided with a valve (not shown) which can be opened or closed to control release of the separated fluid components from the apparatus. Alternatively, the exit pipe (144) may be provided with a three-way valve so that components collected by the separator can be directed into one of two collectors.

As for the apparatus of the first embodiment, the “appropriate” speeds and flow rates for separating a given mixture can be determined empirically by trial and error. Because the separator chamber is at least partially transparent, it is possible to see denser particles accumulating at the periphery of the separator chamber and hence it is possible to judge visually when the separation is complete and hence when to collect the lighter components of the fluid before changing the conditions to collect the denser components.

The apparatus can be used to separate multicomponent mixtures by varying the impeller and separator rotation speeds and the fluid flow rate as described above. For example, to separate a three-component mixture, the rotation speeds and flow rates can be set up to enable collection of a first lighter fraction initially while allowing two heavier fractions to accumulate at the periphery of the separator chamber. Once the lighter component has been collected, the two denser components can be collected and recycled through the apparatus and the rotation speeds and flow rate adjusted so as to separate the two denser components from each other.

By placing a baffle (not shown) in the separator chamber, the efficiency of the separation process can be improved still further, as the baffle will assist in retarding movement of denser fractions along the separator chamber.

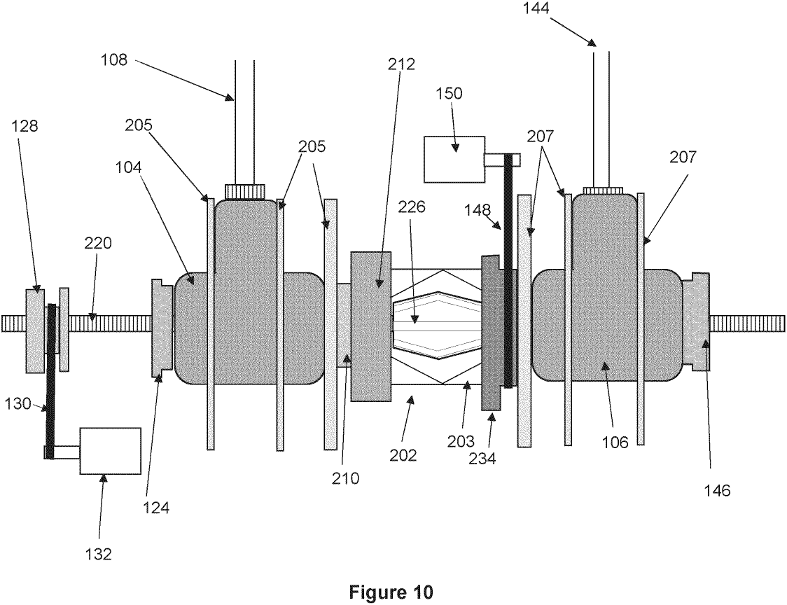

FIG. 10 shows a third embodiment of the invention. This embodiment corresponds to the second embodiment shown in FIGS. 8 and 9 with the only difference being the length of the separator tube (103). A photograph of an apparatus corresponding to these figures is provided as FIG. 12. In the second embodiment shown in FIGS. 8 and 9, the interior of the separator tube defines a separation chamber having a funnel-shaped inlet at its upstream end, a central tubular section with a constant cross-sectional diameter and a funnel-shaped outlet at its downstream end. In the third embodiment shown in FIG. 10, the separator tube has only funnel-shaped inlet and outlet sections and no significant sections where the separator chamber defined by the interior of the separator tube (103) has a constant cross-section.

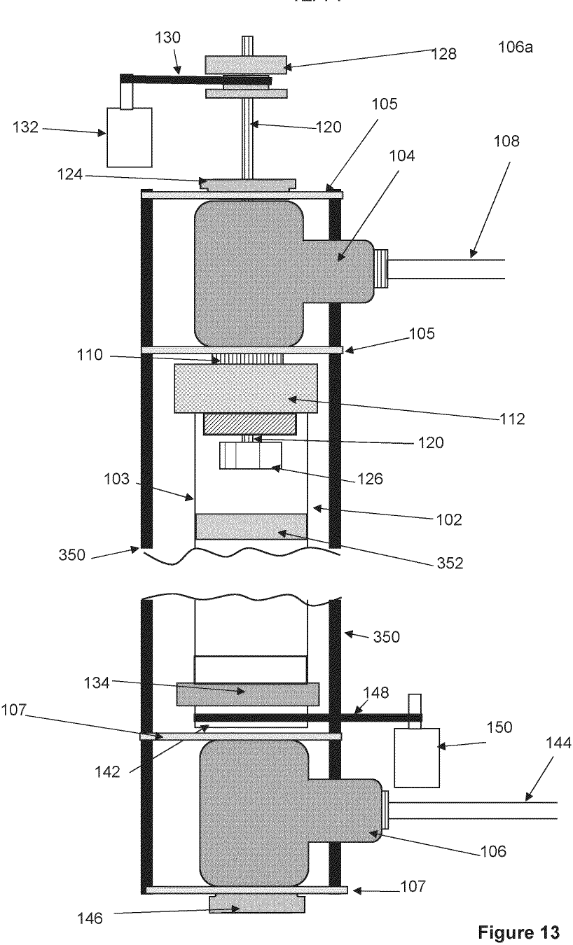

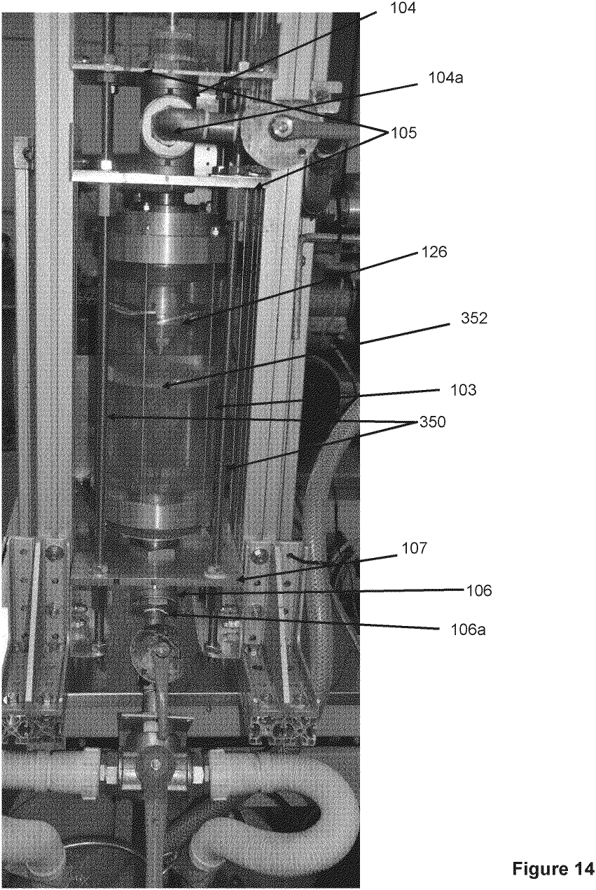

### Fourth Embodiment - FIGS. 13 and 14

An apparatus according to a fourth embodiment of the invention is illustrated schematically in FIG. 13.

FIG. 13 shows an apparatus similar to the one shown in FIGS. 1 to 7B, but wherein the apparatus (specifically the separator tube) is vertically mounted, rather than horizontally mounted. A photograph of an apparatus corresponding to FIG. 13 is provided as FIG. 14.

Unless otherwise specified, components labelled with the same reference numerals used in FIGS. 1 to 7B correspond to the features present in the first embodiment described above.

The apparatus of the fourth embodiment is mounted vertically on four rods. The four rods (350) are secured to a base plate and pass through the metal plates (105, 107) which surround the upstream and downstream T-connector (104, 106). The rods (350) are threaded along their length and therefore the metal plates (104, 106) can be secured at positions along the length of the rods by a pair of nuts.

The apparatus is mounted such that the upstream T-connector (104) is higher than the downstream T-connector (106). Fluid to be separated therefore enters the device at its top and separated components of the fluid stream exit via the bottom.

Within the separator chamber (102) is provided a ring-shaped baffle (352). The ring-shaped baffle is secured within the transparent tube (103) such that there is a fluid-tight fit between the outside of the ring-shaped baffle and the interior of the transparent tube. The ring-shaped baffle (352) defines a hole which is central with respect to the longitudinal axis of the transparent tube (103). The ring-shaped baffle serves to retain heavier materials within the transparent tube (103) while lighter materials can be propelled by the impeller towards to separator chamber exit at the bottom of the apparatus.

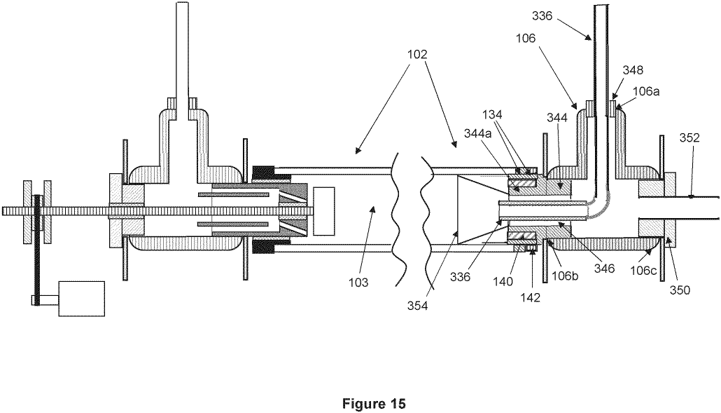

### Fifth Embodiment - FIG. 15

An apparatus according to a fifth embodiment of the invention is illustrated in FIG. 15.

In the fifth embodiment, the upstream end of the apparatus (denoted by the features to the left of the two wavy lines) can be as shown in FIGS. 1 and 2. However, the downstream end of the apparatus (denoted by the features to the right of the two wavy lines) differs in the manner in which it is configured to collect the fluids leaving the separator chamber.

As with the embodiment of FIGS. 1 and 2, the apparatus of FIG. 15 comprises a downstream T-connector (106) on which is rotatably mounted a collar (134) constituting the downstream end formation of the separator chamber (102).

A plug (344) is held within the upstream opening of the downstream T-connector (106) by means of an external thread which engages an internal thread in opening (106b). The plug (344) has a spigot portion (344a) which extends into the downstream end of the separator chamber (102). Mounted on the spigot portion (344a) of the plug (344) is an oil seal bearing assembly (140) on which, in turn, the collar (134) is rotatably mounted.

The plug (344) has a central bore within which is located one end of a cylindrical L-shaped tube (336) which constitutes a first (or inner) collector outlet for the separator chamber (102). An annular space (346) between the collector tube (336) and the wall of the central bore forms a coaxial second (or outer) collector outlet for the separator chamber (102). The other end of the L-shaped tube extends through and is held within a threaded plug (348) mounted in the opening (106a) in the T-connector (106).

The other longitudinal opening (106c) of the downstream T-connector (106) is internally threaded and is closed by a threaded plug (350) which has an externally threaded spigot portion and a hexagonal flange for use in tightening the plug into the opening (106c). The plug (350) has a central bore through which extends an outlet tube (352). A suitable fluid-tight seal (not shown) is provided between the plug (350) and the outlet tube (352).

A funnel (354) is mounted inside the downstream end of the separator chamber (102). The wider (e.g. upstream) end of the funnel is held against the wall of the transparent tube (103) of the separator chamber (102) by means of a friction fit but it could alternatively be held in place by means of adhesive or mechanical fastening elements or, if the separator chamber is formed from a weldable material, by welding. Thus, the funnel (354) rotates with the separator chamber (102).

The narrow (i.e. downstream) end of the funnel surrounds and lies in close proximity to (but without touching) the radially outer edge of the annular space (346).

The apparatus shown in FIG. 15 works in a similar manner to the apparatus of FIGS. 1 and 2, insofar as the upstream end is concerned. Thus, fluid containing components to be separated is pumped through the inlet in the upstream T-connector and into the separator chamber (102) via angled channels. The angled channels impart a degree of rotation to the stream of fluid entering the separator chamber (102). The drive motor (132) (see FIGS. 1 and 2) is then switched on and the drive shaft (120) rotates, thereby to rotate the impeller (126). The spinning impeller imparts further rotation to the fluid stream so that the fluid forms a vortex in the separator chamber (102). Due to the centrifugal forces created by the vortex operating on the components of the fluid, as the vortexed fluid stream passes through the separator chamber (102) the denser component(s) of the fluid are forced to the outer regions of the separator chamber, whilst less dense components follow a path closer to the longitudinal axis of the separator chamber. Once a vortex has been created, the drive motor (150) is switched on so that the drive belt (148) drives rotation of the separator chamber. The rotation can be either in the same direction as the impeller or the opposing direction.

As the fluid travels down the separator chamber (102), the centrifugal forces acting upon it lead to separation of the components of the fluid according to their densities. By selecting an appropriate impeller speed, an appropriate direction and speed of rotation of the separator chamber, and an appropriate flow rate, the denser component(s) of the suspension can be made to accumulate at the outer regions of the separator chamber (102) whilst the less dense component(s) pass along the inner regions of the separator chamber (102).

At the downstream end of the separator chamber (102), the denser components of the suspension move down the funnel (354) and leave the separator chamber through the coaxial second (or outer) collector outlet constituted by the annular space (346). The fluid containing the denser components then passes through the T-connector and out through the outlet (352) to a collector or to waste as required.

The fluid containing the less dense components of the suspension or (depending on the degree of separation, negligible or no suspended components) leaves the separator chamber through the first (or inner) collector outlet constituted by the tube (336). The fluid then passes along the tube (336) and out through the lateral branch of the T-connector to a collector or (depending on whether the desired output is purified fluid or separated particulate matter) to waste.

In an alternative form (not shown) of the apparatus of FIG. 15, the collector tube (336) rather than being L-shaped and being vented via the lateral outlet (106a) of the T-connector, can be a straight length of tubing and can pass through sealed end plug (350). In this alternative embodiment, fluid containing the denser components collected by the second (or outer) outlet can be directed out through a short length of pipe passing through the lateral opening (106a) of the T-connector.

### EXAMPLES OF APPLICATIONS OF THE APPARATUS

The apparatus described above is particularly useful for separating a suspension comprising a solid suspended in water (e.g. removing sand or metal particles from water.

The apparatus may also be used for separating a suspension comprising water and two or more different types of solid materials having different densities.

The following examples describe the separation of components within a fluid stream using the apparatus according to the first embodiment described above, with reference to FIGS. 1 to 7B.

### Example 1

### Separation of Metal Particles From Sand and Grit

(i) A mixture of silt and brass filings (c. 0.007 gms each) is prepared and then added to water to give a suspension containing approximately 15-20% w/w of the solid mixture of silt and metal filings.

The suspension is then pumped into an apparatus of the invention as described above and shown in the Figures via a length of tubing attached to the fluid inlet using the inlet pump. The apparatus has a diverter valve attached to the outlet so that different fractions of the solid mixture can be directed to separate collectors. The bladed impeller is then set to rotate at a given speed and the centrifugal separator chamber is set to rotate at a different given speed in the opposite direction. By appropriate selection of the fluid flow rate through the apparatus, the speed of rotation of the impeller and the speed of rotation of the separator chamber, the centrifugal forces acting on the components of the mixture bring about separation to achieve a steady state at the denser brass filings remain at the radially outer regions of the separator chamber while the less dense silt particles pass along the central region of the separator chamber and out through the outlet and diverter valve where they are collected in a waste container. Once the silt particles have all been collected, the relative speeds of rotation of the impeller and the separator chamber are adjusted so that that the brass particles move from the radially outer periphery of the separator chamber inwardly and into the conical outlet from which they are directed by the diverter valve to a separate collector container.

Before the components of the fluid stream are collected, the suspension can be recycled through the separation apparatus while the relative speeds of rotation of the impeller and separator chamber and the fluid flow rate are adjusted (e.g. by reducing the speed of the impeller) to provide optimal separation, at which point the diverter valve can be set to collect the silt particles.

Once all silt had been removed, the speed of the impeller was reduced to reduce the centrifugal forces acting on the metal filings, so that these could be separated and collected through the inner collector tube.

Using the apparatus of this embodiment, a mixture of silt and brass filings can be completely separated.

The method described above provides a model for the separation of gold particles (and also some non-metallic particles such as diamonds) from silt.

(ii) The usefulness of the apparatus and method of the invention has also been demonstrated by separating a mixture of coarse grit particles and ball bearings. As in example 1(i) above, a suspension of the mixture of particles is introduced into the separator and the speeds of rotation of the impeller and separator chamber and the flow rate of the fluid stream through the separator are adjusted so that the heavier ball bearing fraction is held at the outer periphery of the collector tube while the lighter coarse grit fraction passes along the centre of the collector tube and through the outlet to a first collector container. The speeds of rotation of the impeller and separator chamber and the flow rate of the fluid stream through the separator are then adjusted to allow the ball bearings to move inwardly towards the central opening from which they pass through the diverter valve to another collection container.

### Example 2

### Separation of Heavy Mineral Fractions From Kaolin Mining Waste

Kaolin mining wastes contain coarse grit and a significant proportion (ca. 5% w/w) of a heavy mineral subfraction. Depending on the particular source of the kaolin waste, the heavy mineral subfraction can contain such minerals as zircon, xenotime, rutile and limenite. Zircon (ZrSiO₄) is a mineral belonging to the group of nesosilicates. Within the zircon, numerous heavy rare earth elements (REEs) are present along with uranium and thorium in minor amounts.

The rare earth elements can be for example, one or more selected from cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb) and yttrium (Y).

Xenotime (YPO₄)-Xenotime is a rare-earth phosphate mineral, which may contain trace impurities of arsenic, as well as silicon dioxide and calcium. Numerous other REEs can substitute for the Yttrium in the xenotime making it a significant source of REEs

Rutile (TiO₂)-Rutilated quartz is widely found in nature and rutile sands are a major source of titanium.

Ilmenite (FeTiO3)-Ilmenite, also known as manaccanite, is a titanium-iron oxide mineral. It is a weakly magnetic black or steel-grey solid and, from a commercial perspective, is the most important ore of titanium. Ilmenite is the main source of titanium dioxide, which is used in paints, printing inks, fabrics, plastics, paper, sunscreen, food and cosmetics.

The apparatus of the invention as described above in relation to the Figures can be used in a first separation phase to separate the coarse grit from the heavy mineral subfractions using the method described in Example 1 above to leave a fine sand containing the zircon, xenotime, rutile and ilmenite.

In phase two of the separation, the zircon (which has a specific gravity of 4.6-4.7) can be separated from the other minerals (xenotime - s.g. of 4.4-5.1; rutile (s.g. of 4.5-5.0; and ilmenite (s.g. of ca. 4.79).

In phase three of the separation, by means of fine control of the speeds of rotation of the impeller and separator chamber, and the fluid flow rate, it is envisaged that separation or at least partial enrichment of the xenotime, rutile and ilmenite may be achievable.

The embodiments described above and illustrated in the accompanying figures are merely illustrative of the invention and are not intended to have any limiting effect. It will readily be apparent that numerous modifications and alterations may be made to the specific embodiments shown without departing from the principles underlying the invention. All such modifications and alterations are intended to be embraced by this application.

1. An apparatus for separating components of a fluid stream, the apparatus comprising:
(a) a support structure on which is mounted a rotatable centrifugal separator chamber in which separation of the components of the fluid stream occurs, wherein the centrifugal separator chamber has a longitudinal axis of rotation about which it rotates;
(b) a fluid inlet for introducing a pressurised source of the fluid stream to be separated into the centrifugal separator chamber;
(c) one or more fluid outlets for collecting one or more separated components of the fluid stream, wherein when the apparatus comprises a single fluid outlet, the outlet is centrally located on the axis of the separator chamber and when the apparatus comprises more than one fluid outlet, the outlets are all coaxial with the axis of the separator chamber;
(d) a vortex-creating device which rotates in order to introduce a vortex to the fluid stream in the centrifugal separation chamber thereby to bring about centrifugal separation of the components of the fluid stream;
and wherein the apparatus further comprises a first drive element for rotating the centrifugal separator chamber and a second drive element for rotating the vortex-creating device such that the centrifugal separator chamber and vortex-creating device are configured to rotate independently of each other.

2. An apparatus according to claim 1 wherein the separator chamber is provided with baffles for preventing material accumulating at radially outer regions of the separator chamber from travelling towards the fluid outlet.

3. An apparatus according to claim 2 wherein the baffles are continuous baffles that extend around an entire inner circumference of the separator chamber.

4. An apparatus according to claim 1 wherein the separator chamber is vertically mounted.

5. An apparatus according to claim 1 wherein each of the first and second drive elements comprise a motor and a drive belt.

6. An apparatus according to claim 1 wherein the vortex-creating device is an impeller.

7. An apparatus according to claim 1 wherein the vortex-creating device is located within the centrifugal separator chamber.

8. An apparatus according to claim 1 wherein the fluid inlet (a) is configured to impart a degree of twist to the fluid stream as it enters the centrifugal separator chamber.

9. An apparatus according to claim 8 wherein the fluid inlet (a) comprises one or more inlet channels that are configured and oriented so that the fluid stream enters the centrifugal separator chamber at a peripheral location and at an angle with respect to the longitudinal axis of the centrifugal separator chamber.

10. An apparatus according to claim 1 comprising a single fluid outlet (c) and the outlet is centrally located about the axis of the separator chamber.

11. An apparatus according to claim 1 wherein the fluid outlet (c) comprises a conical funnel.

12. An apparatus according to claim 1 comprising two concentric fluid outlets.

13. An apparatus according to claim 12 wherein the first fluid outlet takes the form of a pipe or tube and the second fluid outlet takes the form of an annular space surrounding the pipe or tube.

14. An apparatus according to claim 1 wherein the support structure (a) comprises:
an inlet block which is in fluid communication with the fluid inlet (b); and
an outlet block, which is in fluid communication with the fluid outlet (c);
and the rotatable centrifugal separator chamber extends between and is rotatably mounted on the inlet and outlet blocks;
the inlet block having a rotatable drive shaft extending therethough and into the separator chamber, the rotatable drive shaft being connected to the vortex-creating device (d) within the rotatable centrifugal separator chamber and being linked at a location externally with regard to the inlet block and the rotatable centrifugal separator chamber to a drive element.

15. An apparatus according to claim 1 wherein the separator chamber is formed from a transparent material.

16. An apparatus according to claim 1 further comprising or being associated with a tank comprising the fluid to be separated, wherein the tank optionally comprises a submersible pump for pumping the fluid to be separated to the fluid inlet (b).

17. A method for separating components of a suspension, the method comprising passing the suspension through an apparatus as defined in claim 1.

18. A method for separating a mixture of different types of particles contained in a solid mixture, wherein the different types of particles have differing densities, the method comprising:
a) forming a suspension of the solid mixture by adding the solid mixture to a carrier liquid (e.g, water); and
b) passing the suspension as a fluid stream through an apparatus according to claim 1; and
c) separating the different types of particles according to their densities by controlling the fluid flow rate through the separator chamber, the speed of rotation of the separator chamber and the speed of rotation of the vortex-creating device as defined herein.

19. An apparatus according to claim 2 wherein the separator chamber is vertically mounted.

20. An apparatus according to claim 3 wherein the separator chamber is vertically mounted.
